(19) United States
(12) Patent Application Publication
(10) Pub. No.: US 2018/0069384 A1
(43) Pub. Date: Mar. 8, 2018

(54) ELECTRICAL INSULATION STRIPPING SYSTEMS, METHODS, AND DEVICES

(71) Applicant: Q Factory 33 LLC, Encinitas, CA (US)

(72) Inventor: Paul Martin Cruz, San Diego, CA (US)

(21) Appl. No.: 15/697,259

(22) Filed: Sep. 6, 2017

Related U.S. Application Data
(60) Provisional application No. 62/384,062, filed on Sep. 6, 2016.

(51) Int. Cl. H02G 1/12

(52) U.S. Cl. CPC H02G 1/1224

(57) ABSTRACT

An insulation stripping tool can be used to precisely remove a section of insulation located away from the edges of an insulated wire. The insulation stripping tool includes two transverse cutting elements which can be spaced a predefined and precise distance apart, and upper and lower longitudinally-extending cutting elements extending between the transverse cutting elements. Hinged lever arms can be gripped to move the cutting elements towards one another and cut into the insulation sheathing an insulated wire. A depth guide may be included to control the depth of the insulation cut to minimize or avoid scoring or otherwise affecting the conductive core of the insulated wire.

### CROSS-REFERENCE TO RELATED APPLICATIONS

This application claims the benefit of U.S. Provisional Application No. 62/384,062, filed Sep. 6, 2016, entitled ELECTRICAL INSULATION STRIPPING SYSTEMS, METHODS, AND DEVICES, which is hereby incorporated by reference in its entirety.

### FIELD

This disclosure relates to devices for stripping insulation from electrical wires or cables. More specifically, this disclosure relates to hand-held devices that mechanically cut through and remove a predetermined length (or portion) of the insulation surrounding an electrical conductor, leaving intact the insulation on both sides of the portion of the insulation that is stripped.

### BACKGROUND

When an electrician needs to strip insulation from an electrical wire or cable, there are at least two options/approaches readily available. If the portion of the insulation to be stripped is immediately adjacent to an end of the wire or cable, an electrician's knife is commonly used. The knife blade is pressed against the insulation, to the point of piercing the insulation, and then rotated 360°, thereby circumferentially severing the endmost piece of insulation surrounding the conductor. At this point, with the knife blade nearly touching the conductor, the thumb of the hand holding the knife is pressed against the side of the wire or cable opposite the blade, and the severed insulation is then simply pulled off, exposing a desired length of bare conductor. For obvious reasons, such use of a metallic knife blade is not always the favored approach when the conductor is live.

Another approach commonly utilized when stripping insulation nearest the end of a wire or cable (sometimes referred to as “end stripping”) involves a gauged, pliers-type insulation-stripping device having two jaws (i.e., an upper jaw and a lower jaw), each of which being configured with one or more semi-circular shaped recesses having a bladed edge. When the jaws of such a device are fully closed around an insulated electrical wire or cable, cutting circles of predetermined diameter—just slightly larger than the diameter of the electrical conductor inside of and corresponding to the selected gauge of insulated electrical wire or cable—are created. The severed insulation is then stripped off the conductor by sliding the device toward the nearest end of the electrical wire or cable.

In so-called “mid-span stripping”—the type of stripping to which the embodiments of this disclosure are primarily directed—the portion of insulation to be stripped from an insulated electrical wire or cable is located along the length of the wire or cable and not, as in the end-stripping scenarios detailed above, immediately adjacent to an end thereof. In other words, mid-span stripping removes a portion of insulation on a wire (or cable) that is not adjacent to an end of the wire such that after the insulation is removed there is still other insulation along the wire between the stripped portion of the insulation and an end of the wire. Although both the knife and conventional pliers-based stripping approaches are also frequently employed in mid-span stripping scenarios, each of these approaches has disadvantages when compared to embodiments described in this disclosure.

Because the portion of insulation to be removed via mid-span stripping is of a predetermined/required length (e.g., ⅝″, 1″, 1½″, etc.) based on the purpose of removing the insulation, several disadvantages of the knife-based stripping approach become evident when this technique is employed in mid-span stripping scenarios. The first disadvantage arises from the fact that to ensure that the insulation to be stripped off is the proper length, the electrician must first measure out and score (or otherwise mark-up) the insulation prior to cutting it with the knife. Measurement and marking processes such as these are notoriously susceptible to human error. But even in those instances when the marking up of the insulation is accurately performed, the act of cutting the insulation with a knife often proves to be an unwieldy, and thus error-prone, process. It simply is difficult to maintain a straight-line cut around a circular wire or cable with an implement such as a knife, which can turn in the hand during use. And even fairly slight deviations from straight-line cutting of the insulation surrounding large-diameter conductors can be problematic, because in order to pass inspection, the length of insulation removed in a mid-span stripping procedure must be precise; that is to say, any exposure of the underlying conductor beyond the required length may constitute a major violation of the electrical code. In addition, stripping wires in-place may be difficult due to other wires, structures or electrical components that are positioned near the wire to be stripped, and hinder access to the wire.

A conventional pliers-based stripping device is shown in U.S. Pat. No. 3,902,206, which describes the mid-span stripping of insulation surrounding an electrical cable by first cutting the insulation transversely (i.e., perpendicularly to its length) in two distinct, axially separated locations by, in each case, closing cutting elements around the insulation and, if necessary, turning the cutting elements about the cable; the resulting length of insulation, so cut, is then slit by running a blade element longitudinally (i.e., axially) between these two transverse cuts; and finally, the cut and slit length of insulation is then gripped with an insulation peeler and pulled from the cable. Disadvantages of this approach include the measurement and marking process addressed above with regard to knife-based stripping: that is, one could still inadvertently cut off a longer-than-required piece of insulation by overestimating the required separation between the two transverse cuts; for that matter, one could, by following the approach described in the '206 patent, also inadvertently cut a longer slit than required in the insulation; and finally, the step of pulling the insulation from the cable with the device described in the '206 patent could not be performed with a live conductor, as only the handles of the device are taught as being covered with an electric insulating material.

### SUMMARY

The systems, methods, and devices of this disclosure each have several innovative aspects, no single one of which is solely responsible for the desirable attributes disclosed herein.

Embodiments disclosed herein relate to a handheld insulation-stripping device. In one embodiment, the insulation-stripping device includes a first pliers-type insulation-cutting mechanism and a second pliers-type insulation-cutting mechanism. Each of the first pliers-type insulation-cutting mechanism and a second pliers-type insulation-cutting mechanism includes an upper (or first) jaw and lower (or second) jaw. The insulation-stripping device is configured to operate such that the first and second jaws can be opened (moved apart) and closed (moved together) using their handles. The first and second jaws of each of the first pliers-type insulation-cutting mechanism and a second pliers-type insulation-cutting mechanism can be closed on a wire (or cable, both generally referred to herein as a “wire”) that the jaws are positioned around. The use of “upper” and “lower” herein in reference to the jaws, or the first pliers-type insulation-cutting mechanism and a second pliers-type insulation-cutting mechanism, are merely used for ease of reference as relative terms, to indicate a certain relative position of one or the other when the insulation stripping device is at a particular orientation, and are not meant to limit the orientations at which the handheld insulation stripping device can be used to strip insulation.

The first and second pliers-type insulation-cutting mechanisms are mechanically coupled to one another, for example, via rivets (or another fastener) inserted through and secured to their respective handles, the rivets also passing through two spacer elements disposed between the respective handles, such that the first pliers-type insulation-cutting mechanism and second pliers-type insulation-cutting mechanism mechanically move together when operated to close onto a wire or to open to release from a wire or to be positioned around a wire. For ease of reference, the first plier-type insulation-cutting mechanism and second pliers-type insulation-cutting mechanism may be referred to herein as the first cutting mechanism and the second cutting mechanism, respectively.

In some embodiments, a “longitudinal” cutting blade, for cutting insulation along the length of a wire, is attached to a jaw of the handheld insulation-stripping device. In various embodiments, such a cutting blade is attached to one or both of the jaws of one or both of the first and second pliers-type insulation-cutting mechanisms. A semi-circular cutting blade is included in the jaw of each of the two pliers-type insulation-cutting devices, such that when the respective upper jaw and respective lower jaw of each of the two separate pliers-type insulation-cutting devices are brought together in abutting arrangement, by grasping the respective handles of each device and squeezing them together.

The cutting edge of the semi-circular blades are disposed at about a right angle from the longitudinal cutting blade, although in various embodiments the angle may be slightly different than a right angle. The orientation of the semi-circular blade and the longitudinal blade are such that when the insulation-stripping device is used to strip insulation from a wire, the semi-circular blade cuts insulation in a cross-sectional direction on the wire and the longitudinal blade cuts insulation along the length of the wire during the same cutting operation. A circular cutting aperture may be disposed in each of the first and second pliers-type insulation-cutting mechanisms (forming a circular aperture when the jaws are closed), allowing the conductive portion of a wire to pass through the jaws without being cut by the semi-circular blades. The circular aperture may be sized such that a wire being of a certain gauge and having a certain thickness of insulation can be placed in the aperture, and when the jaws are closed on the wire the semi-circular blades cut the insulation but do not cut the center conductive wire. For example, with wire of 12 AWG (American Wire Gauge), the conductive center may be between about 0.081 inches and 0.095 inches in diameter, and have an outside thickness with thermoplastic insulation of about 0.152 inches. If the insulation-stripping device was configured to strip the insulation off of such a wire, the aperture size (diameter) when the jaws were closed would be configured to be large enough so the conductive center of the 12 AWG wire is not cut (for example, about 0.095 inches) but small enough to cut through the insulation. The insulation-stripping device may have a similar configuration for wire of any size from, for example, 24 AWG to 1 AWG, 1/0, 2/0, 3/0, 4/0, or 250 MCM through 2000 MCM. These sizes are examples and not meant to be limiting.

Although the respective circular cutting apertures are in axial alignment with one another, they are axially displaced from one another by a predetermined distance. For example, the distance may be ⅛ inch or smaller, or one inch or two or larger. In some embodiments, the distance is between ½ inch and 1 inch.

As mentioned above, in addition to the two circular cutting apertures of the handheld insulation-stripping device of the embodiment described above, this embodiment further comprises two longitudinal, or axial, insulation-cutting blades that are disposed perpendicularly to and extend the entire length between the semi-circular cutting blades, one of the longitudinal insulation-cutting blades having a beveled cutting blade facing downwards and secured between the respective upper jaw of the insulation-stripping device, and one of the longitudinal insulation-cutting blades having a beveled cutting blade facing upwards and secured between the respective lower jaw of the handheld insulation-stripping device.

In some other embodiments, pre-fabricated handles are configured to accept cutting blades that are removable attachable to the handles, the cutting blades being chosen to accommodate a particular gauge of wire or cable that is desired to be stripped in a certain use of the tool, as well as the length of insulation that is to be stripped.

In still other embodiments, the separation of the two axially aligned circular cutting apertures of the cutting blades may be made to be adjustable. That is, for a given gauge of wire or cable, the length of insulation to be stripped may be selected by adjusting mechanical means that separate the circular cutting apertures within a desired range. In one embodiment, the insulation cutting device includes a pair of upper longitudinal insulation-stripping blades. One end of one blade of the pair secured to the left upper jaw of the upper jaw of the handheld device, and one end of the other blade of the pair secured to the right upper jaw of the upper jaw of the handheld device. A pair of lower longitudinal insulation-cutting blades are positioned and configured similarly, the two blades of each respective pair being disposed in a parallel abutting arrangement, such that for the minimum separation of the two circular cutting apertures, the two blades of each pair completely overlap one another. For the maximum separation of the two circular cutting apertures, the two blades of each pair have been longitudinally translated, each with respect to the other, such that the free end of each blade in each pair is brought very nearly to the center position, axially speaking, between the circular cutting apertures.

In some embodiments, the handle(s) of the insulation-stripping device may be made out of/from any suitable electrically insulating material, for example, plastic, fiberglass, wood. This allows the insulation-stripping device to be used to strip the insulation from live wires/cables in a safe manner.

### BRIEF DESCRIPTION OF THE DRAWINGS

Certain inventive aspects will hereinafter be described in conjunction with the appended drawings, provided to illustrate and not to limit the disclosed aspects. In these figures, reference numerals are generally used to indicate the same component; however, for clarity of description, various configurations of an indicated component may all be referred to using the same reference numeral. In some figures, components that are indicated by a reference numeral, and that also are illustrated in other figures, may not be each time, again in the interest of clarity of disclosure; and in such cases, other description of such commonly referenced components in other implementations may apply, unless otherwise indicated, explicitly or by context.

FIG. 1 is an exploded perspective view of an example of a handheld insulation-stripping device.

FIG. 2 is a perspective view of the insulation-stripping device illustrated in FIG. 1 with its jaws partially open.

FIG. 3A is a left-hand side isolation view illustrating an example of the cutting blades of a handheld insulation-stripping device with its jaws partially open, drawn at one example of the size of the device.

FIG. 3B is a front view of a handheld insulation-stripping device with its jaws partially open.

FIG. 3C is a left-hand perspective view isolating the partially open jaws of an insulation-stripping device.

FIG. 4A is another perspective view of a portion of an insulation-stripping device illustrating the closed jaws of the insulation-stripping device.

FIG. 4B is another perspective view illustrating, in isolation, the closed jaws of a insulation-stripping device.

FIG. 4C is a side view of a handheld insulation-stripping device

FIG. 4D is a top, or bottom, view of the closed jaws of an insulation-stripping device

FIG. 4E is a left-of-center end-on view of the closed jaws of an insulation-stripping device

FIG. 5A is a side view of a pair of transverse cutting elements having an integrated depth guard structure.

FIG. 5B is a side view of the pair of transverse cutting elements of FIG. 5A, brought into close proximity with one another.

FIG. 6A is a cross-sectional view of a pair of cutting elements and an insulated wire, each of the pair of cutting elements including a longitudinal cutting element and two transverse cutting elements with an integrated depth guard structure.

FIG. 6B is a cross-sectional view of the pair of cutting elements and the insulated wire of FIG. 6A, the cutting elements being brought into close proximity with one another so as to cut into the insulated wire.

### DETAILED DESCRIPTION

While the present disclosure is susceptible of embodiments in many different forms, there is shown in the drawings, and will herein be described in detail, various embodiments, with the understanding that the present disclosure is to be considered as an exemplification of the principles of the and is not intended to limit the broad aspects of the to the illustrated embodiments. As used herein, the term “instant disclosure” or “present disclosure” is not intended to limit the scope of the claimed embodiments, but is instead a term used to discuss exemplary embodiments for explanatory purposes only.

Embodiments of the present disclosure relate to systems and techniques for implementing devices and methods that can be used to strip (i.e., remove) insulation from electrical wires or cables.

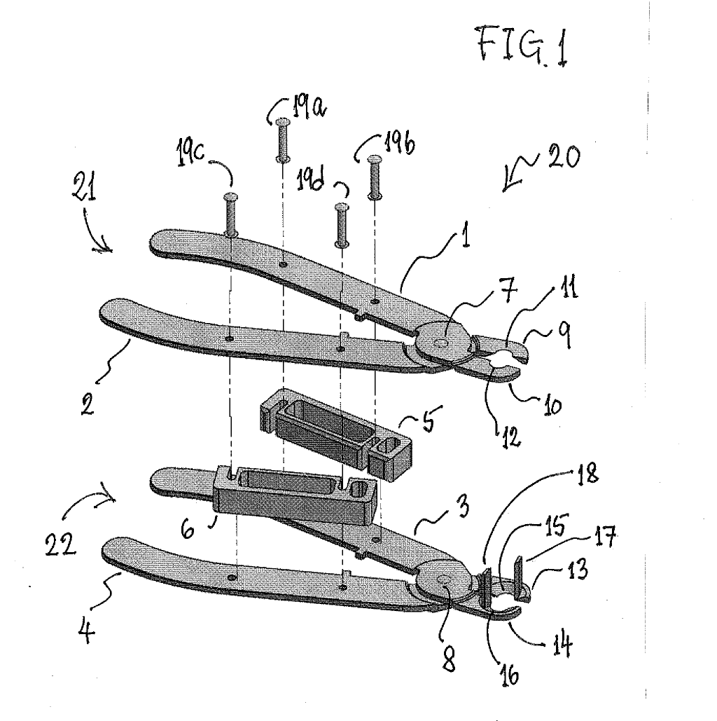

FIG. 1 illustrates an exploded perspective view of a handheld insulation-stripping device 20. As illustrated, the insulation-stripping device 20 comprises a pliers-type first insulation cutting device 21 and a pliers-type second insulation cutting device 22.

The first insulation cutting device 21 includes a first handle 1 and a second handle 2. The first handle 1 is fixedly attached to or integrally formed with lower jaw 10, the lower jaw 10 including or attached to a cutting blade 12 (e.g., a beveled cutting blade) along an inner portion of the lower jaw 10, that is, a portion of the lower jaw 10 that is positioned proximate to an upper jaw 9. The cutting blade 12 may also be referred to herein as a transverse cutting blade or a transverse cutting element. The cutting blade 12 may be semi-circular in shape, as illustrated in FIG. 1. The second handle 2 is fixedly attached to or integrally formed with the upper jaw 9, the upper jaw 9 including or attached to a cutting blade 11 (e.g., a beveled cutting blade) along an inner portion of the upper jaw 9, that is, a portion of the upper jaw 9 that is positioned proximate to the lower jaw 10. The cutting blade 11 may be semi-circular in shape, as illustrated in FIG. 1. The cutting blade 11 may also be referred to herein as a transverse cutting blade or a transverse cutting element.

The first and second handles 1 and 2 are pivotally attached to each another via pivot mechanism 7, illustrated in this embodiment as pin 7. The upper jaw and the corresponding lower jaw (that operate together to close onto a wire) may be referred to herein as a set of jaws. Accordingly, the upper jaw 9 and the lower jaw 10 may be referred to together as a first set of jaws, and the upper jaw 13 and the lower jaw 14 may be referred to together as a second set of jaws.

The second insulation cutting device 22 includes a first handle 3 and a second handle 4. The first handle 3 is fixedly attached to or integrally formed with lower jaw 14. The lower jaw 14 includes or is attached to a cutting blade 16 (e.g., a beveled cutting blade) along an inner portion of the lower jaw 16, that is, a portion of the lower jaw 16 that is positioned proximate to an upper jaw 13. The cutting blade 16 may be semi-circular in shape, as illustrated in FIG. 1. The cutting blade 16 may also be referred to herein as a transverse cutting blade or a transverse cutting element. The second handle 4 is fixedly attached to or integrally formed with the upper jaw 13. The upper jaw 13 includes or is attached to a cutting blade 15 (e.g., a beveled cutting blade) along an inner portion of the upper jaw 13, that is, a portion of the upper jaw 13 that is positioned proximate to the lower jaw 14. The cutting blade 15 may be semi-circular in shape, as illustrated in FIG. 1. The cutting blade 15 may also be referred to herein as a transverse cutting blade or a transverse cutting element. The first handle 3 and the second handle 4 of the second insulation cutting device 22 are pivotally attached to each another via pivot mechanism 8, illustrated in this embodiment as pin 8.

The first insulation cutting device 21 is fixedly attached to the second insulation cutting device 22 such that they may be operated in unison to cut insulation. In the embodiment illustrated in FIG. 1, the first insulation cutting device 21 is fixedly attached to the second insulation cutting device 22 by coupling first handle 1 of the first insulation cutting device 21 to the first handle 3 of the second insulation cutting device 22, and coupling the second handle 2 of the first insulation cutting device 21 to the second handle 4 of the second insulation cutting device 22.

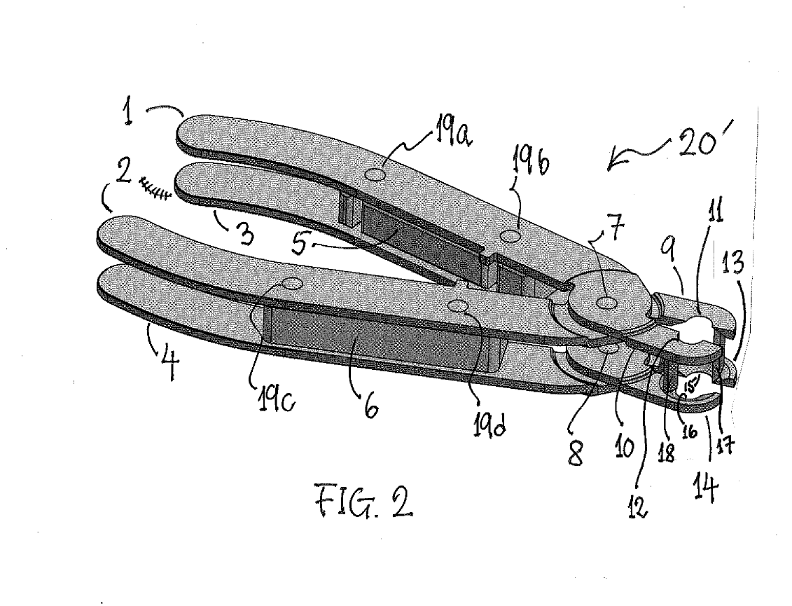

For example, the first handle 1 may be coupled to the first handle 3, and the second handle 2 may be coupled to the second handle 4, through the use of rivets 19a-19d, with spacers 5 and 6 providing the necessary rigidity of the assembled device 20′ (depicted in FIG. 2). In some embodiments, prefabricated handles may be fashioned from any suitable material that is electrically insulating (non-conductive). For example, in some embodiments, materials such as plastic, epoxy resin, fiberglass, and wood, may be used, although a wide variety of other suitable materials may also be used.

The insulation-stripping device 20 includes one or more longitudinal insulation cutting blades that operate to cut insulation along the length of a wire. The insulation-stripping device 20 illustrated in FIG. 1 includes two longitudinal insulation cutting blades or elements, each of the longitudinal cutting blades disposed or extending between the first insulation cutting device 21 and a second insulation cutting device 22. Specifically, in this embodiment the insulation-stripping device 20 includes a first a first (or upper) longitudinal insulation cutting blade 17 and a second (or lower) longitudinal insulation cutting blade 18. These cutting blades 17 and 18 are positioned near the cutting blades 11, 12, 15, and 16 and arranged such that their cutting surfaces are aligned at an angle from the cutting edge of cutting blades 17 and 18, for example, in a perpendicular angle or an angle that is substantially perpendicular. In some embodiments, the angle may be in the range of 70-110 degrees from the angle of the cutting blades 17 and 18. In some embodiments, the longitudinal cutting blade is positioned at an angle between 85 and 95 degrees from the angle of the cutting blades 11, 12, 13, and 14.

The first longitudinal insulation-cutting blade 17 has a first end and a second end and may be affixed or otherwise in contact or in close proximity, at the first end, to cutting blade 15. The lower longitudinal insulation-cutting blade 18 has a first end and a second end and may be affixed or otherwise in contact or in close proximity, at the first end, to lower cutting blade 16. As illustrated, the upper longitudinal insulation-cutting blade 17 is disposed at the forward-most portion of the semi-circular cutting blade 11, while the lower longitudinal insulation-cutting blade 18 is disposed at the rearward-most portion of the semi-circular cutting blade 16. In this arrangement, the longitudinal insulation-cutting blades provides excision of the insulation between the two transverse circular cuts.

In some embodiments, the longitudinal cutting blades may be disposed at a slight angle relative to the length of the wire or cables. However, the first ends of longitudinal insulation-cutting blades 17 and 18, respectively, may also be affixed at other positions along the respective arcs of lower semi-circular cutting blades 15 and 16. In some embodiments, the second ends of longitudinal insulation-cutting blades 17 and 18 may be respectively seated in recesses (not shown) made in upper semi-circular cutting blades 11 and 12, and in some embodiments they may also be affixed to the upper semi-circular cutting blades 11 and 12. In still other embodiments, both the first and second ends of longitudinal insulation-cutting blades 17 and 18 may be secured to the upper and lower jaw of the first and second pliers-type insulation cutting devices 21 and 22 via securement screws or any other suitable attachment or securement means.

In the illustrated embodiment, the longitudinal cutting blades 15 and 16 are located at different distances from the pin 8, and therefore travel within generally circular paths of different radii when the insulation-stripping device 20 is operated. In other embodiments, however, the longitudinal cutting blades 15 and 16 may be disposed at similar locations with respect to the semi-circular cutting blades 15 and 16, such that they travel within generally circular paths of substantially similar radii when the insulation-stripping device 20 is operated. In some particular embodiments, the longitudinal cutting blades 15 and 16 may be positioned such that they are positioned substantially parallel to a diameter of the generally circular space defined by the cutting surfaces of the semi-circular cutting blades 15 and 16 when the semi-circular cutting blades 15 and 16 are brought into close proximity with one another.

In some embodiments, the cutting surfaces of the semi-circular blades 15 and 16 may each comprise a semi-circular arc of roughly 180 degrees, although in other embodiments, the cutting surfaces of the blades 15 and 16 may comprise arcs of different lengths which, when combined, define a generally circular space. For example, the cutting surface of the transverse blade 15 may comprise an arc greater than 180 degrees, and the cutting surface of the transverse blade 16 may comprise an arc less than 180 degrees.

In the illustrated embodiment, the spacers have a fixed dimension defining the spacing between the first insulation cutting device 21 and the second insulation cutting device 22, such that the transverse cuts made by the first insulation cutting device and the second insulation cutting device will be spaced apart from one another by a precise and consistent distance. In other embodiments, dimensions of the insulation-stripping device 20 may be adjustable. For example, if the spacers are adjustable, or if the spacing between the transverse cutting elements are otherwise adjustable, the width of the section of insulation to be stripped can be adjusted. In some embodiments, this may be freely adjustable, while in other embodiments, this may be adjustable between a plurality of precisely-defined positions. In one particular embodiment, the longitudinal insulation-cutting blades 17 and 18 may include a plurality of individual blade elements, forming an cutting structure of an adjustable length. For example, the longitudinal insulation cutting blades may include a first blade secured relative to one transverse cutting element and a second blade secured to the other transverse cutting element, such that the blades overlap when the transverse cutting elements are closer together, but maintain a cutting structure across the entire space between the transverse cutting elements when the transverse cutting elements are farther apart.

FIG. 2 illustrates an assembled handheld insulation-stripping device 20 such as that described above with regard to FIG. 1. The illustrated handheld insulation-stripping device 20 can be operated by a person who is either left-handed or right-handed. The insulation stripping device 20 can be sized to different dimensions for various embodiments of the insulation-stripping device 20. For example, the longitudinal separations between the first insulation cutting mechanism 21 and the second insulation cutting mechanism 22 can be anywhere between about ¼″ to 12″, and the upper and lower longitudinal cutting blades 17, 18 may be similarly sized. In some particular embodiments, the separation is between about ½″ and 1 inch, for example, ⅝″. The separation between the first insulation cutting mechanism 21 and the second insulation cutting mechanism 22 can define the spacing between the transverse cuts to be made in the insulation of an insulated wire, and therefore the width of the longitudinal section of insulation which will be stripped by the insulation-stripping device.

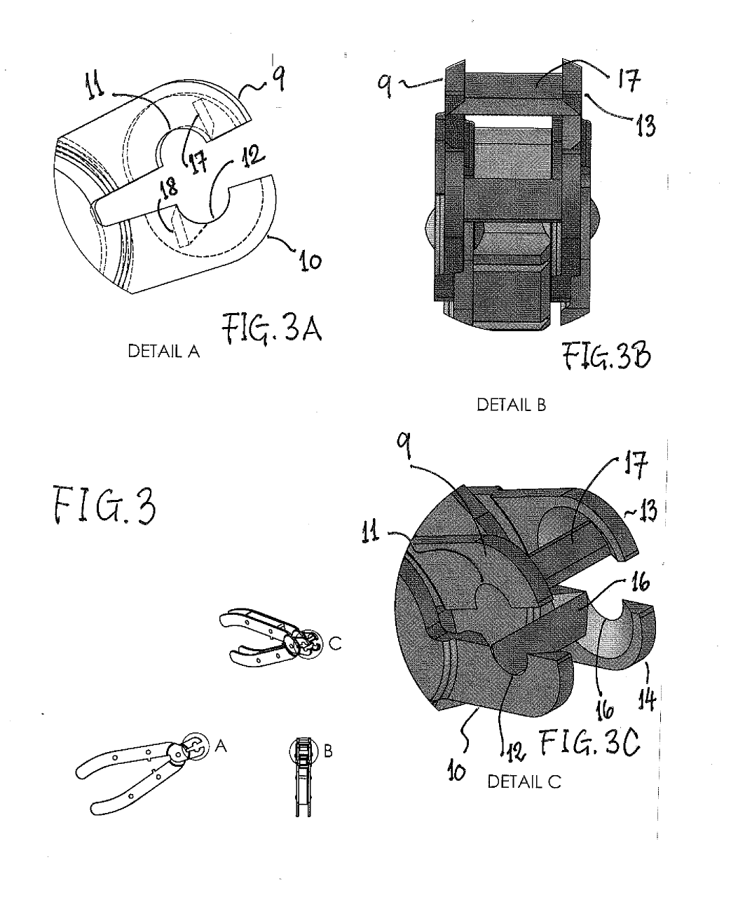

FIG. 3A illustrates a left-hand side isolation view of an example of a handheld insulation-stripping device. As illustrated, a beveled, semi-circular insulation-cutting blade 11 is recessed in upper jaw 9, and an upper longitudinal insulation-cutting blade 17 is disposed at the forward-most portion of semi-circular blade 11. Similarly, a beveled, semi-circular insulation-cutting blade 12 is recessed in lower jaw means 10, and a lower longitudinal insulation-cutting blade 18 is disposed at the rearward-most portion of the semi-circular blade 12. As discussed elsewhere herein, the longitudinal blades 17, 18 may be disposed in other positions on the semi-circular blades in other embodiments.

As further illustrated, upper jaw 9 and lower jaw 10 are angularly displaced from one another, which will be the case when the insulation-stripping device is opened prior to its being positioned about an electrical wire or cable from which a given length of insulation is to be stripped. It should be noted that the circular cutting diameter that results when the respective upper and the lower jaws of the handheld device are brought into abutting contact (when the handles of the device are gripped and brought together) corresponds to the cross-sectional thickness of the electrical conductor within the wire or cable that is to be stripped.

The respective placement of the cutting edges of the upper and lower longitudinal insulation-cutting blades 17 and 18 depicted in this figure defines the manner in which the insulation of a wire will be cut. While the insulation of the wire or cable (not shown) that is to be stripped is being cut transversely by the semi-circular insulation-cutting blades 11, 12 and 15, 16, respectively, it is simultaneously cut longitudinally by blades 17 and 18. The combined effect of these cuts is such that the insulation in the area between the semi-circular insulation-cutting blades 11, 12 and 15, 16 defines two semi-cylindrical pieces of insulation. For certain sizes of the semi-circular insulation-cutting blades relative to the insulated wire, these semi-cylindrical pieces of insulation can be completely cut through and separated from the adjacent insulation and each other, such that they may fall away from the wire or cable after the handheld device is operated. This operation may comprise, for example, positioning the cutting device about the insulated wire or cable, gripping the same, and rotated the cutting devices slightly (e.g., a rotation of +/−5° (0.087 radians)) about the wire, and opening the device.

FIG. 3B illustrates a front view of a handheld insulation-stripping device with its jaws partially open. As illustrated, longitudinal insulation-cutting blade 17 is shown disposed between jaws 9 and 13. FIG. 3C illustrates a left-hand perspective view isolating the partially open jaws of a insulation-stripping device, as described above in greater detail with regard to FIG. 2.

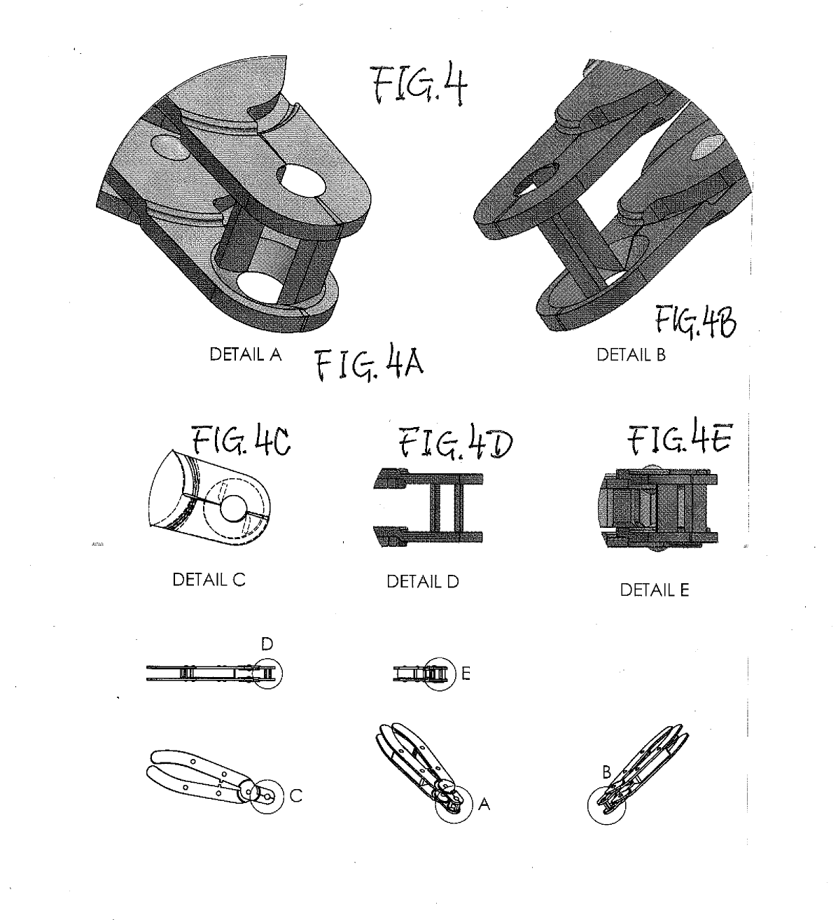

FIG. 4A illustrates a downward-facing perspective view isolating the closed jaws of a insulation-stripping device such as the device described above in greater detail with regard to FIG. 2. FIG. 4B illustrates a downward-facing perspective view isolating the closed jaws of a insulation-stripping device such as the device described above in greater detail with regard to FIG. 2. FIG. 4C illustrates a left-side view of a insulation-stripping device such as the device described above in greater detail with regard to FIG. 3A. FIG. 4D illustrates a top (or bottom) isolation view of the closed jaws of a handheld insulation-stripping device such as the device described in greater detail elsewhere in the specification. FIG. 4E illustrates a left-of-center end-on view of the closed jaws of a handheld insulation-stripping device such as the device described in greater detail elsewhere in the specification.

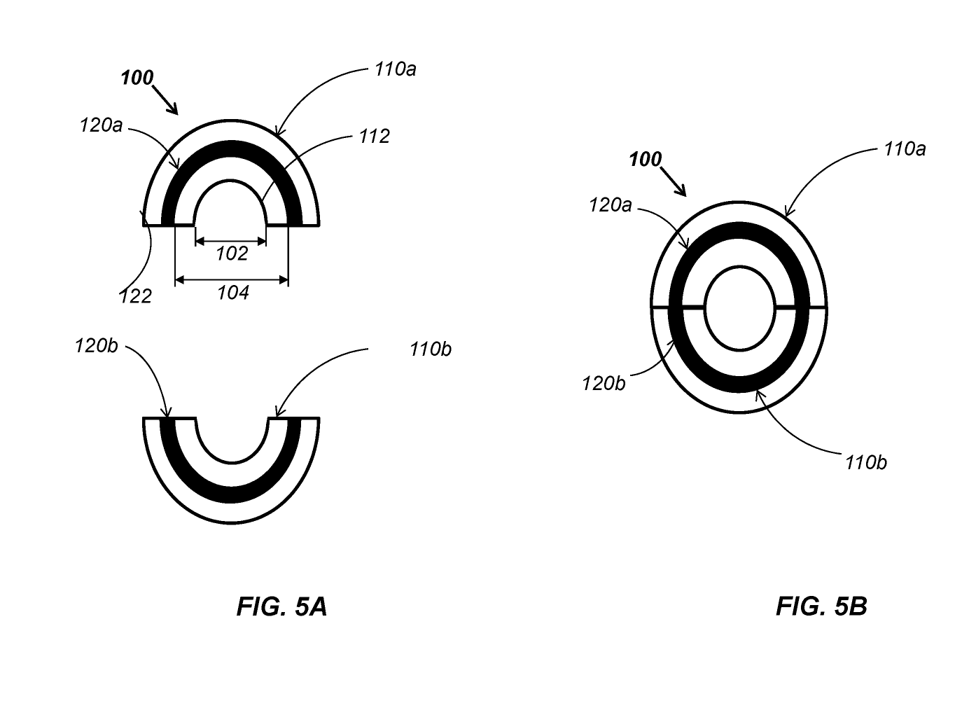

FIG. 5A is a side view of a pair of transverse cutting elements having an integrated depth guard structure. FIG. 5B is a side view of the pair of transverse cutting elements of FIG. 5A, brought into close proximity with one another.

In particular, FIGS. 5A and 5B illustrate the outer surfaces of a pair of transverse cutting elements 110a and 110b, similar to the semi-circular insulation-cutting blades 11, 12 and 15, 16 described above. The transverse cutting elements 110a and 110b may be made from any suitable material, and may be semi-circular or any other desired shape, in profile. In combination, the transverse cutting elements 110a and 110b form a transverse cutting mechanism.

The transverse cutting elements 110a and 110b are dimensioned to cut insulation from a given gauge of wire. In particular, the cutting surfaces 112 of the transverse cutting elements 110a and 110b are in the shape of a circular arc, such as a semi-circular arc, having a diameter 102. The diameter of the circular arc of suitably dimensioned cutting surfaces 112 can accommodate the conductive core of an insulated wire during a wire stripping process, such as where the conductive core has a similar or smaller diameter than the diameter of the circular arc of the cutting surfaces 112.

When insulation from a wire is to be stripped, transverse cutting elements 110a and 110b are sufficiently separated from one another to allow insulated wire of a given gauge to be accommodated between transverse cutting elements 110a and 110b. In some embodiments, the transverse cutting elements 110a and 110b may be separated from one another by a distance sufficient to position the insulated wire such that no part of its outer diameter, including the insulation, is touching the transverse cutting elements 110a and 110b. Once the wire is positioned between transverse cutting elements 110a and 110b, upper and lower handles attached or otherwise operably coupled to transverse cutting elements 110a and 110b (such as the handles described with respect to FIGS. 1 and 2) are closed toward one another, thereby bringing transverse cutting elements 110a and 110b into contact with the respective upper and lower portions of insulation surrounding the wire.

In the event that the process described above is performed symmetrically, that is, neither the upper nor lower cutting element is brought into contact with the insulation surrounding the wire before the opposing cutting element is brought into contact with the insulation on the opposite side of the wire, the insulation neatly be cut close to or at the depth of the conductor at the core of the wire. This precise cut may be formed, for example, where the conductive core of the wire has a similar or slightly smaller diameter than the diameter of the circular arc of the cutting surfaces 112.

If, however, a user inadvertently places one or the other transverse cutting elements 110a and 110b on the insulated wire before the opposing blade is closed about the opposite side of the wire, and pressure is applied to the handle operably coupled to the cutting element brought prematurely into contact with the insulation, one runs the risk of cutting through the insulation on that side as well as scoring the conductor beneath the insulation. Such scoring of conductors may result in the integrity of the conductor being slightly, moderately, or even severely compromised.

In order to reduce, minimize, or eliminate the risk of scoring or other damage to the conductive core of the insulated wire being stripped, the transverse cutting elements 110a and 110b include depth guards 120a and 120b, respectively. The depth guards 120a and 120b may be fixedly attached to, or otherwise secured relative to, the transverse cutting elements 110a and 110b. In some embodiments, the depth guards 120a and 120b may be fixedly attached to substrate materials from which the transverse cutting elements 110a and 110b are fashioned by means of grinding, milling, or other appropriate fabrication process.

In the illustrated embodiment, the depth guards 120a and 120b are semi-cylindrical structures extending outward from the outer surface of the transverse cutting elements 110a and 110b. The semi-cylindrical depth guards 120a and 120b have an inner diameter 104 which is larger than the inner diameter of the cutting surfaces 112 of the transverse cutting elements 110a and 110b.

Depth guards 120a and 120b are configured and dimensioned to mitigate the risk of compromising the integrity of the conductor portion of an insulated wire. The innermost surface (that is, the surface closest the insulation of a wire about which transverse cutting elements 110a and 110b are disposed) of each depth guard 120a and 120b is a surface disposed at a distance from its respective cutting blade such that, in the event that one or the other cutting element is pressed against the insulation of the wire before the opposing cutting blade has been brought into contact with the opposite side of the insulated wire, the depth gauge acts as a physical stop, preventing that blade from penetrating far enough into the insulation to compromise, either partially or severely, the integrity of the conductor beneath the insulation.

In some embodiments, the depth guards 120a and 120b need not be a contiguous structure extending substantially around the entire transverse cutting element, but may instead include one or more structures having inner surfaces aligned with a circular arc of diameter 104. In some embodiments, the depth guards 120a and 120b may be a generally planar surface or shelf-like structure, which extend parallel to the lower surfaces of the transverse cutting elements. In some embodiments, the depth guards 120a and 120b need not be on the outer surface of the transverse cutting elements, but may instead be on the inner facing surfaces of the transverse cutting elements. Generally, a depth guard structure may comprise blunt projections disposed relative to the transverse cutting elements such that the shortest distance between a portion of the depth guard and a portion of the transverse cutting surface is less than or equal to the thickness of the insulation for a given gauge of wire

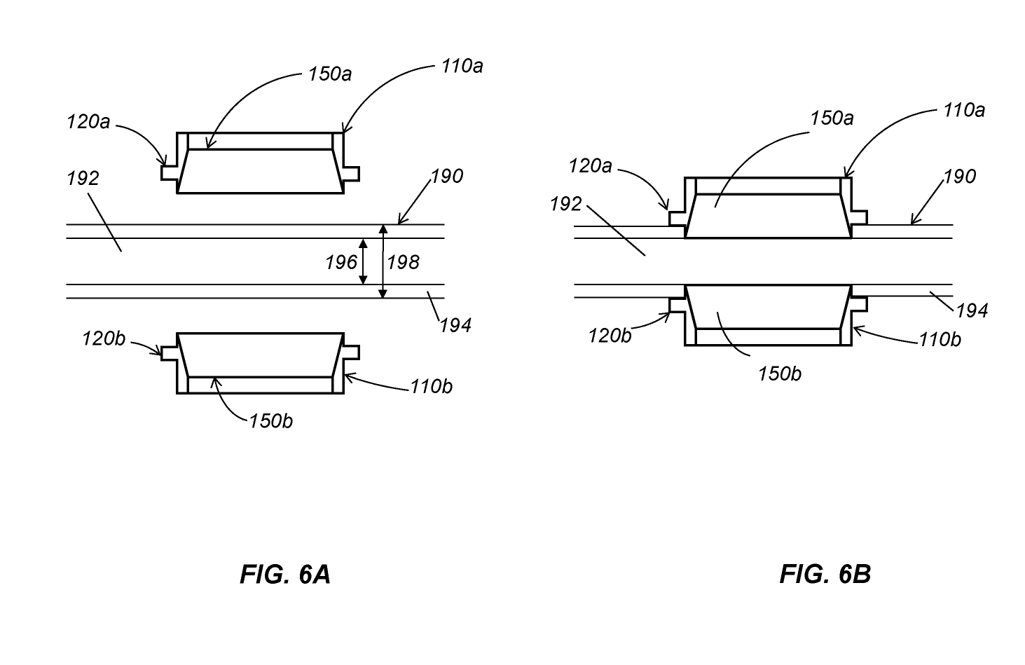

FIG. 6A is a cross-sectional view of a pair of cutting elements and an insulated wire, each of the pair of cutting elements including a longitudinal cutting element and two transverse cutting elements with an integrated depth guard structure. FIG. 6B is a cross-sectional view of the pair of cutting elements and the insulated wire of FIG. 6A, the cutting elements being brought into close proximity with one another so as to cut into the insulated wire.

It can be seen in FIG. 6A that the distance between the radially innermost sections of the upper transverse cutting elements 110a and the radially innermost sections of the upper depth guards 120a is substantially equal to the thickness of the insulation 194 surrounding the conductive core 192 of the insulated wire 190. Similarly, the distance between the radially innermost sections of the lower transverse cutting elements 110b and the radially innermost sections of the lower depth guards 120b is also substantially equal to the thickness of the insulation 194. It can also be seen that the radially innermost sections of the transverse cutting elements 110a and 110b and the radially innermost sections of the longitudinal cutting elements 150 are located at substantially the same radial position.

In FIG. 6B, the upper and lower cutting structures are brought into contact with or close proximity to one another, where the outer and/or inner edges (not visible in the plane of FIGS. 6A and 6B) of the transverse cutting elements 110a and 110b abut or are brought into close proximity with another. The transverse cutting elements 110a and 110b cut through all or substantially all of the insulation 194 surrounding the conductive core 192 of the insulated wire 190, but the comparatively wide contact surfaces of the depth guards 120a and 120b, compared to the thin cutting edge of the cutting members, stops against the insulation and centers the cutting structures, preventing or minimizing scoring of the conductive core 192 by the cutting structures.

In particular, the diameter 104 of the depth guard structures 120a and 120b can be substantially equal or slightly smaller than the total outer diameter of 198 of the insulated wire 198. The diameter 102 of the cutting surfaces of the transverse cutting elements 110a and 110b can be substantially equal to or slightly larger than the diameter 196 of the conductive core 192 of the insulated wire 190.

It can also be seen that the upper and lower longitudinal cutting elements 150a and 150b make the longitudinal cuts in the upper and lower sections of the insulation 194 within substantially the same plane (e.g., the plane of FIG. 6B), as discussed above. In such an embodiment, the upper and lower longitudinal cutting elements 150a and 150b may be disposed at substantially identical distances from the pivot point of the cutting tool.

When the cutting tool is gripped to push the cutting elements into the insulation 194, as shown in FIG. 9B, two semi-cylindrical sections of the insulation 194 will be defined. Each section extends between the left transverse cut (which extends all or substantially all of the way around the wire) and the right transverse cut (which extends all or substantially all of the way around the wire) made in the insulation. The first semi-cylindrical section extends around the wire beginning at the longitudinal cut made in the upper section of the wire 190 and extending around the wire core 192 and ending at the longitudinal cut made in the lower section of the wire 190. The second semi-cylindrical section is located on the opposite side of the plane of the page and extends around the wire beginning at the longitudinal cut made in the upper section of the wire 190 and extending around the wire core 192 and ending at the longitudinal cut made in the lower section of the wire 190

In the foregoing description, specific details are given to provide a thorough understanding of the examples. However, it will be understood by one of ordinary skill in the art that the examples may be practiced without these specific details. Certain embodiments that are described separately herein can be combined in a single embodiment, and the features described with reference to a given embodiment also can be implemented in multiple embodiments separately or in any suitable subcombination. For example, various components or devices may be described in general terms or illustrated schematically, in order not to obscure the examples in unnecessary detail. In other instances, such components, other structures and techniques may be shown in detail to further explain the examples.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An insulation stripping device, comprising:
a first cutting structure, the first cutting structure comprising:
a first transverse cutting element having a curved cutting surface in the shape of a circular arc;
a second transverse cutting element having a curved cutting surface in the shape of a circular arc; and
a first longitudinal cutting element extending between the first transverse cutting element and the second transverse cutting element; and
a second cutting structure hingedly movable relative to the first cutting structure, the second cutting structure comprising:
a third transverse cutting element having a curved cutting surface in the shape of a circular arc and located opposite the first transverse cutting element;
a fourth transverse cutting element having a curved cutting surface in the shape of a circular arc and located opposite the second transverse cutting element; and
a second longitudinal cutting element extending between the third transverse cutting element and the fourth transverse cutting element.

2. The device of claim 1, wherein, when the first cutting structure is moved to a position proximate the second cutting structure:
the cutting surfaces of the first transverse cutting element and the third transverse cutting element define a first circular space therebetween; and
the cutting surfaces of the second transverse cutting element and the third transverse cutting element define a second circular space therebetween, wherein the first circular space is the same diameter as the second circular space.

3. The device of claim 2, wherein, when the first cutting structure is moved to a position proximate the second cutting structure, the distance between the first longitudinal cutting element and the second longitudinal cutting element is substantially equal to the diameters of the first and second circular spaces.

4. The device of claim 2, wherein, when the first cutting structure is moved to a position proximate the second cutting structure, the diameters of the first and second circular spaces are substantially equal to or slightly larger than the diameter of a conductive core of an insulated wire to be stripped by the insulation stripping device.

5. The device of claim 1, wherein, when the first cutting structure is moved to a position proximate the second cutting structure, the first longitudinal cutting element is substantially coplanar with the second longitudinal cutting element.

6. The device of claim 1, wherein the first cutting structure comprises a first depth guard and the second cutting structure comprises a second depth guard, wherein a minimum radial distance between the first depth guard and the cutting surface of the first transverse cutting element is substantially equal to a minimum radial distance between the second depth guard and the cutting surface of the second transverse cutting element.

7. The device of claim 6, wherein the minimum radial distance between the first depth guard and the cutting surface of the first transverse cutting element is substantially equal to or greater than the thickness of an insulation layer to be removed by the insulation stripping device.

8. The device of claim 1, wherein the first depth guard comprises a substantially semicylindrical inner contact surface in the shape of a circular arc, the diameter of the circular arc of the depth guard being larger than the diameter of the cutting surface of the a first transverse cutting element.

9. The device of claim 1, wherein the first cutting structure is disposed at the end of a first lever arm, and the second cutting structure is disposed at the end of a second lever arm hingedly connected to the first lever arm.

10. A handheld insulation-stripping device for removing a desired length of insulation from an insulated electrical wire or cable, the device comprising:
first and second upper jaw means and first and second lower jaw means, wherein the first upper jaw means and the first lower jaw means each have a complementarily beveled, semi-circular insulation-cutting blade recessed therein, such that when the first upper jaw means and the first lower jaw means are brought into abutting arrangement on an insulated electrical wire or cable, a first transverse circular blade is created that circumferentially severs the insulation, and such that when the second upper jaw means and the second lower jaw means are brought into abutting arrangement on an insulated electrical wire or cable, a second transverse circular blade is created that circumferentially severs the insulation, the first transverse circular blade and the second transverse circular blade being displaced, one from the other, by a predetermined longitudinal distance along the axis of the electrical wire or cable;
an upper longitudinal insulation-cutting blade and a lower longitudinal insulation-cutting blade, the upper longitudinal insulation-cutting blade being disposed, blade side down, along the entire longitudinal distance between and an inner lateral surface of the first upper jaw means and an inner lateral surface of the second upper jaw means, and the lower longitudinal insulation-cutting blade being disposed, blade side up, along the entire longitudinal distance between an inner lateral surface of the first lower jaw means and an inner lateral surface of the second lower jaw means, such that when the respective upper and lower jaw means of the device are brought into abutting arrangement on an insulated electrical wire or cable, two semi-cylindrical pieces of insulation of a predetermined longitudinal length are stripped from the wire or cable, and fall away from the wire or cable after the device is opened and the respective upper and lower jaws of same are thereby angularly displaced; and
a first handle coupled to the upper jaw means and a second handle coupled lower jaw means.

11. The handheld insulation-stripping device of claim 10, wherein the handles means comprise a non-conductive material.

12. The handheld insulation-stripping device of claim 10, wherein either or both the upper longitudinal insulation-stripping blade and the lower longitudinal insulation-stripping blade made be disposed non-orthogonally with respect to the inner lateral surfaces of the respective upper and lower jaw means.

13. A hand-operated insulation stripping device, comprising:
a first cutting blade disposed in a first set of jaws;
a second cutting blade disposed in a second set of jaws, wherein the first and second cutting blades being arranged at a distance d apart, and wherein the first and second sets of jaws are arranged in a substantially parallel configuration such that the first and second cutting blades are also in a substantially parallel configuration; and
at least one longitudinal cutting blade coupled to at least one of the first or second set of jaws, the at least one longitudinal cutting blade disposed between the first and second set of jaws.

14. The device of claim 13, wherein the at least one longitudinal cutting blade extends from the set of jaws to which it is attached, towards the other set of jaws, and wherein the at least one longitudinal cutting blade has a length l of at least ½ of the distance d.

15. The device of claim 14, wherein the distance d is greater than ⅛″.

16. The device of claim 14, wherein the at least one longitudinal cutting blade length l is between ⅜″ and 1.5″.

17. The device of claim 13, wherein the at least one longitudinal cutting blade comprises at least two longitudinal cutting blades.

18. The device of claim 13, wherein the first cutting blade and the second cutting blade each include a substantially semi-circular aperture configured to allow the center conductive portion of a wire to pass through the first and second blade without being cut by the first and second cutting blade when they are closed onto the wire.

19. The device of claim 18, wherein the semi-circular aperture is sized of a suitable size to allow wire being of a gauge of 1 AWG to 250 AWG to pass through the semi-circular aperture.

20. The device of claim 13, further comprising
a first handle coupled to a first jaw of the first set of jaws and a second jaw of the second set of jaws, the first handle configured to move the coupled to jaws when the handle is moved; and
a second handle coupled to a second jaw of the first set of jaws and a second jaw of the second set of jaws, the second handle configured to move the coupled to jaws when the handle is moved.
